(19) United States
(12) Patent Application Publication
(10) Pub. No.: US 2014/0164624 A1
(43) Pub. Date: Jun. 12, 2014

(54) Systems and Methods for Managing a Virtual Infrastructure

(71) Applicant: Panavisor, Inc., San Jose, CA (US)

(72) Inventors: William Ames, San Jose, CA (US); Robert P. Zager, Saratoga, CA (US); Scott A. Sachtjen, San Jose, CA (US); Michael Stewart Mazarick, Raleigh, NC (US)

(73) Assignee: Panavisor, Inc., San Jose, CA (US)

(21) Appl. No.: 14/182,899

(22) Filed: Feb. 18, 2014

Related U.S. Application Data
(63) Continuation of application No. PCT/US12/51622, filed on Aug. 20, 2012.
(60) Provisional application No. 61/527,033, filed on Aug. 24, 2011.
(60) Provisional application No. 61/525,715, filed on Aug. 19, 2011.

(51) Int. Cl. H04L 12/911

(52) U.S. Cl. CPC H04L 47/70
USPC 709/226

(57) ABSTRACT

This disclosure includes example methods and systems comprising at least one computer server including at least a cloud computing manager configured to determine a location for instantiating at least one virtual machine in at least one cloud network using a weighted rating engine, interface with at least one user via a management console, and communicate with the at least one cloud network.

### REFERENCE TO RELATED CASES

This patent application claims priority under 35 U.S.C. §120 to and is related to International application no. PCT/US12/51622 filed 20 Aug. 2012, which claims priority from U.S. provisional application No. 61/527,033 filed 24 Aug. 2011, and U.S. provisional application No. 61/525,715 filed 19 Aug. 2011, which are hereby incorporated by reference in their entirety.

### TECHNICAL FIELD

This application relates to the field of data processing in shared computing environments, and in particular to managing, allocating, and instantiating computing resources.

### BACKGROUND

Cloud computing allows for configuring computing resources (e.g., networks, servers, storage, applications, services, and so on) to be shared over a network. The concept of cloud computing fills a perpetual need of computing space.

IT services by increasing capacity and adding capabilities on the fly without investing in new infrastructure, training new personnel, or licensing new software. Cloud computing can be used to provide services for computation, software, data access, and storage without the need for end-user knowledge of the physical location or configuration of the system delivering the services.

Conventionally, cloud computing providers deliver applications via the Internet, which are accessed from a Web browser, while the business software and data are stored on servers at a remote location. Most cloud computing infrastructures consist of services delivered through shared data-centers that appear as a single point of access for consumers' computing needs. IT services are based on Internet protocols, dynamically scalable, and often virtualized resources. Web-based tools or applications are convenient for dynamically accessing cloud resources through a Web browser designed to give the effect of programs installed locally on a user's own computer.

Given the vast number and location of resources, however, cloud computing providers are often faced with latency and accessibility problems during delivery of services, which may be due to one or more drawbacks such as transfer rates, delayed response, availability, overflow, cost, unpredictable consumption rates, privacy, and so on.

### SUMMARY

Disclosed here includes, for example, a system and method comprising at least one computer server including at least a cloud computing manager configured to determine a location for instantiating at least one virtual machine in at least one cloud network using a weighted rating engine, interface with at least one user via a management console, and communicate with the at least one cloud network.

For example, the cloud management system and method wherein the manager is further configured to communicate the determination of the location for instantiating the at least one virtual machine to the at least one user, receive user information regarding the determination, and instantiate the at least one virtual machine at a location in the cloud network based on the received user information.

In another example the methods and systems of the cloud management wherein the manager is further configured to instantiate the at least one virtual machine at a location in the cloud network based on the location determined by the weighted rating engine. Further, the cloud management system and methods wherein the manager is hosted by a cloud service provider, or, for example wherein the manager is hosted in a private cloud available only to one enterprise.

Additionally, in an example embodiment, the cloud management systems and methods wherein the location that the weighted rating engine determines to instantiate the at least one virtual machine is in a public cloud network. Also, the cloud management systems and methods could include wherein the location that the weighted rating engine determines to instantiate the at least one virtual machine is in a private cloud network.

In yet another embodiment, the cloud management systems and methods could include wherein the location that the weighted rating engine determines to instantiate the at least one virtual machine is in an enterprise physical resource. Another example is where the cloud management systems and methods wherein the manager is further configured to cluster at least two management consoles, wherein the two or more management consoles are each configured to make at least one request into the system. Further, the cloud management systems and methods wherein the manager is further configured to include at least one hypervisor in its determination of the location of the instantiation of the at least one virtual machine. Another example includes where the cloud management systems and methods wherein the manager is further configured to generate at least one report including at least information regarding the location in the at least one cloud network of the at least one virtual machine.

Another example embodiment includes systems and methods comprising at least one computer server including at least a cloud computing manager configured to determine a location for instantiating at least one virtual machine in at least one cloud network via a weighted rating engine using at least one key factor, interface with at least one user via a management console, communicate with the at least one cloud network, and instantiate the at least one virtual machine in the at least one cloud network based on the determination of the weighted rating engine.

In another example embodiment, the cloud management systems and methods wherein the at least one key factor includes an actual cost to instantiate the at least one virtual machine. Further, the embodiment could include the cloud management systems and methods wherein the at least one key factor includes network latency from a point of use to the at least one virtual machine. And the cloud management systems and methods may include wherein the at least one key factor includes information from at least one governmental requirement regarding the function of the at least one virtual machine.

Still anther example embodiment may include where the cloud management systems and methods include wherein the governmental requirement includes information regarding at least one of: health regulations, tax regulations, and financial regulations. Another example is wherein the manager is further configured to generate at least one report including at least information regarding the location in the cloud network of the at least one virtual machine. Still another example embodiment includes where the cloud management systems and methods wherein the manager is further configured to generate at least one report including at least information regarding the key factors used for determination of the location of the at least one virtual machine.

An example embodiment of the inventions disclosed here includes a distributed management system comprising at least one computer server including at least a cloud computing manager configured to determine a location for instantiating at least one virtual machine in at least one cloud network via a weighted rating engine using at least one key factor, interface with at least one user via at least two management consoles, communicate with the at least one cloud network, and instantiate at least one virtual machine in the at least one cloud network based on the determination of the weighted rating engine.

Another example of the distributed management systems and methods may include wherein the at least two management consoles are configured to receive requests regarding instantiation of at least one virtual machine from at least one of a remote: site, entity and organization. Another example may be the distributed management systems and methods wherein the at least two management consoles are further configured to receive rules that limit the requests of the at least one remote, the limit including at least one of: location of the at least one virtual machine, type of virtual machine, number of virtual CPUs utilized, amount of storage used, and amount of memory used.

Further examples may include the distributed management systems and methods wherein the instantiation of the at least one virtual machine is in the at least one cloud network. Another example may be the distributed management systems and methods wherein the instantiation of the at least one virtual machine is in the at least one physical resource of the requesting remote.

Still another example embodiment includes a digital rights management (DRM) system for managing digital rights in a virtual infrastructure, comprising, a manager configured to, generate encryption key pairs, including at least a public and a private key, encrypt at least one virtual machine with the at least one private key, and securely distribute the at least one public key to instantiators of the at least one virtual machine.

In certain example embodiments, the digital rights management systems and methods include wherein the instantiators of the at least one virtual machine is in at least one of: a public cloud network, a private cloud network and a physical system. Other examples may include the digital rights management systems and methods wherein the at least one virtual machine is configured to contain meta data and reveal only within an at least one cloud computer network that meets the usage requirements of the meta data. Another example includes the digital rights management systems and methods wherein the at least one virtual machine is configured to contain meta data and instantiate only within an at least one cloud computer network that meets the usage requirements of the meta data.

Another example includes the digital rights management systems and methods wherein the secure distribution of the at least one public key includes a trusted platform module and a trusted computing environment. Another may be the digital rights management systems and methods wherein the encryption includes a digital signature.

Yet another example embodiment includes a system comprising, a cloud manager in a computer network cloud environment configured to, determine a location for instantiating at least one virtual machine in at least one cloud network, generate at least one report regarding the location where the at least one virtual machine is instantiated, and communicate the at least one report to at least one client, wherein the reports include at least one of, a location map, resource utilization report, network latency report, software license tracking, physical machine capacity usage report, and resource uptime report.

Another example includes the cloud management systems and methods wherein the reports are configured for auditing. Yet another example is the cloud management systems and methods wherein the reports are configured for cost analytics. Still another example embodiment includes the cloud management systems and methods wherein the reports are configured for Business Intelligence analytics. And another example is the cloud management systems and methods wherein the reports are configured for at least one of rolling back, moves, adds, and/or changes.

### BRIEF DESCRIPTION OF THE DRAWINGS

For a better understanding of the embodiments described in this application, reference should be made to the description below, in conjunction with the following drawings in which like reference numerals refer to corresponding parts throughout the figures.

FIG. 1 is a system diagram of a cloud computing system, according to some embodiments.

FIG. 2 is a system diagram of cloud computing system, according to some other embodiments.

FIG. 3 is block diagram of a management system, according to some embodiments.

FIG. 4 is a system diagram illustrating a detailed view of a customer network system, according to some embodiments.

FIG. 5 is a system diagram illustrating a detailed view of a management system, according to some embodiments.

FIG. 6 is a flow chart illustrating the operation of generating and enforcing policies, according to some embodiments.

FIG. 7 is block diagram illustrating multiple virtualization platforms being supported by a management system, according to some embodiments.

FIG. 8 is block diagram illustrating the components of a management system console, according to some embodiments.

FIG. 9A is a Venn diagram illustrating centralized services, according to some embodiments.

FIG. 9B is block diagram illustrating the physical system control, according to some embodiments.

FIG. 10 is a block diagram of a management system application store, according to some embodiments.

FIG. 11 is a graphical representation of an enterprise view extension, according to some embodiments.

### DETAILED DESCRIPTION

Reference will now be made in detail to embodiments, examples of which are illustrated in the accompanying drawings. In the following description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of any invention(s) to these particular embodiments. In other instances, well-known data structures, timing protocols, software operations, computing devices, procedures, and components have not been described in detail so as not to unnecessarily obscure aspects of the embodiments of the invention(s).

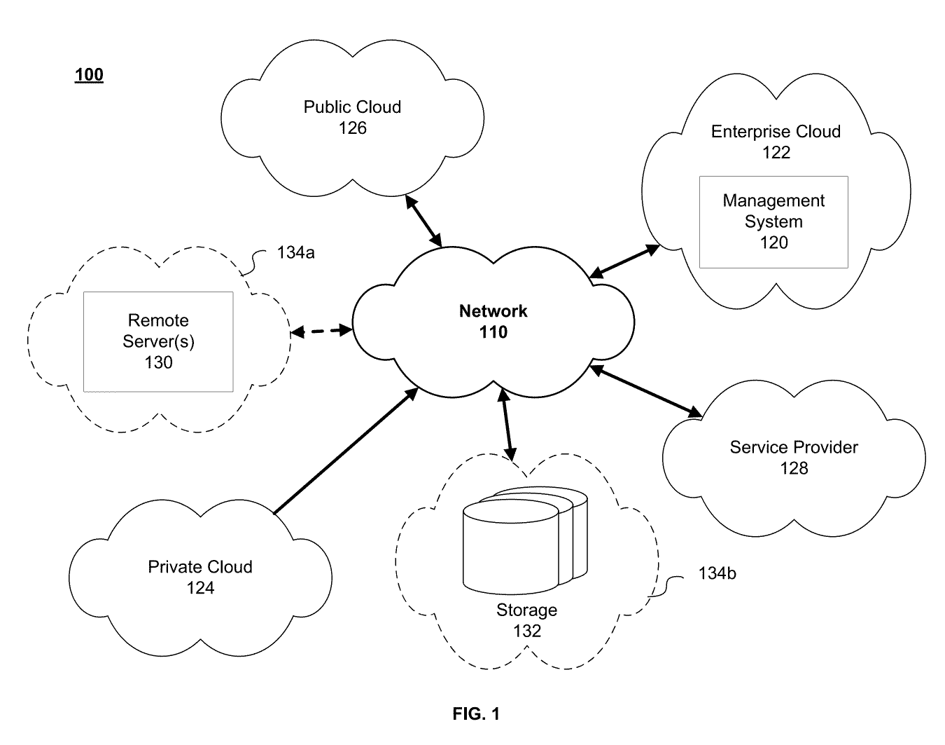

FIG. 1 is a system diagram of a cloud computing system 100 according to some embodiments. The system includes a management system 120 in an enterprise cloud 122 configured to communicate with other clouds and/or systems via a network 110. The management system 120 includes a weighted rating engine to determine the optimal location for instantiating a virtual machine (“VM”) or multiple VMs. The weighting feature of the management system 120 can be configured to place more weight or relevance on one key factor. In some embodiments, a higher weight or relevance may be placed on a handful of key factors, depending on the customer or determined from customer preferences. In some embodiments, the weight or relevance may be equally distributed across a pool of factors.

The weighting engine considers any number of factors, which include but is not limited to, Service Level Agreements (“SLAs”) from service providers, customer/client preferences, requirements for availability, relative location of services, degree of latency, security, governance issues, availability of local resources, hypervisor features, cost of computing resources, cost of storage resources, and so on.

The enterprise cloud 122 may be a company that hosts the management system 120, and may be either a private cloud or an organization with its own physical infrastructure. The enterprise cloud 122 may rely on the management system 120 to service its own users on-premise, or it may service its customers who may or may not be on-premise. In some embodiments, the enterprise cloud 122 may service a combination of customers on- and off-premise.

Customers who are serviced by the management system 120 and/or the enterprise 122 may be individual users, a group of users, a corporation or organization, a group of organizations, groupings of organizations, or any combination thereof. The customer may be a service provider of one or more services within the cloud computing system 100.

In some embodiments, customers may be users or an organization that uses one or more client device (not shown) to request service or access cloud computing services provided by the management system 120 or the enterprise cloud 122. Client devices can be any of a number of devices (e.g., a computer or any portable handheld device such as: an internet kiosk, a personal digital assistant, a mobile phone device, any portable handheld device, a gaming device, a desktop computer, a tablet, or a laptop computer). The client device may include client applications that are accessed or serviced by the enterprise 122 and/or the management system 120, and/or client memory. The client application can be software that permits a user to interact with cloud computing resources provided by the managements system 120 over the network 110 to, for example, perform one or more tasks.

In some embodiments, a customer may place a higher relevance on a specific commerce-based resource such as a financial database or contents of an SLA with one or more service providers. In the meanwhile, factors such as network location and price of services may have a lower relevance.

In one example, a HIPAA database may include certain governance requirements that prevent data from being stored off-shore. In this case, the weighting engine may place a higher relevance for local facilities or seek out SLAs from service providers that guarantee regional data storage. Thus, when the management system 120 makes its determination, the highly relevant factors are given more weight to identify and select the physical resources relied upon for instantiating the VM(s).

In another scenario, a quality assurance (“QA”) resource may be the focal point for product testing. The weighting preferences may be higher for factors that results in providing the least cost and shortest network delay.

The management system 120 may also be enabled to generate recommendations and/or rules for instantiating a VM. In some embodiments, the management system 120 can be configured to make automatic location selections for VM instantiation based on user or customer input and system requirements. The management system 120 may also be configured to generate reports, wherein the reports may include forecasts that could be generated to map potential cost analysis, performance capabilities, congestion, resource availability, and so on.

In some embodiments, the management system 120 may be configured to be compatible with various cloud provider Application Programming Interfaces (“APIs”), such as, for example but not limited to, Amazon EC Web Services API, OpenStack API, vCloud VMware, Windows AZURE API, GoGrid API, and so on. Thus, the management system 120 may be able to create virtual device instances and manage them across multiple platforms and/or simultaneously across multiple platforms. Similarly, the management system 120 may also be compatible with various storage provider APIs, such as, but not limited to, Amazon S3 API, CloudNAS API, and so on. Similarly, the management system 120 may be designed to support multiple hypervisors, such as, but not limited to VMWare, Citrix, KVM, and so on.

The network (110) can be any wired or wireless local area network (LAN), metropolitan area network, and/or wide area network (WAN), such as an intranet, an extranet, or the Internet, or it may be a combination of such networks. The network 110 provides communication capabilities between the enterprise cloud 122 and other clouds or client devices at other network sites. In some embodiments, the network 110 uses the HyperText Transport Protocol (HTTP) to transport information using the Transmission Control Protocol/Internet Protocol (TCP/IP). The HTTP permits client devices to access various data and applications available from the management system 120 via the network 110. The various embodiments of the invention(s), however, are not limited to the use of any particular protocol.

The management system 120 may communicate with other clouds via the network 110, such as public cloud 126, other private clouds 124, or service providers that reside in other clouds 128, which may be either another public or private cloud.

The public cloud 126 may host resources are dynamically accessible to the public on a self-service basis over the Internet, via web applications/web services, from an off-site third-party provider, and so on. The infrastructure of the private cloud 124 may be operated for an organization, managed internally, or by a third-party service provider 128. The private cloud 124 may include an infrastructure that may be between multiple organizations in a community that may have common concerns (e.g., security, compliance, jurisdiction, and so on.). The service provider 128 may provide services for operating cloud computing services, or one or more sub-services for a cloud computing infrastructure that may, for example, reside on the public cloud 126, private cloud 124, or the enterprise cloud 122. The management system 120 coordinate the use of resources or services provided by the service provider cloud 128.

In some embodiments, the management system 120 residing in enterprise cloud 122 may service customers on-premise and off-premise utilizing resources from the enterprise cloud 122, public cloud 126, private cloud 124, or service provider 128 in any combination. For example, customers that are on-premise at enterprise cloud 122 may be provided services by the management system 120 from public cloud 126, private cloud 124, or service provider 128. For example, VMs may be instantiated from physical systems (not shown) located on any of these other clouds. Conversely, the management system 120 may provide services from the enterprise cloud 122 to customers from public cloud 126, private cloud 124, or service provider 128.

Remote storage 132 stores data and remote server(s) may process/compute tasks to support the management system 120. In some embodiments, the management system 120 may communicate with remote server(s) 130 via the network 110, in addition to local servers that may reside on-premise, for processing cloud computing services. Similarly, the management system 120 may utilize resources from remote storage 132 in addition to or alternatively from storage that is available on-premise at the enterprise cloud 122. In some embodiments, the management system 120 utilizes a combination of resources on-premise and off-premise, such as remote server(s) 130 and remote storage 132. In some embodiments, server(s) 130 may be hosted by other clouds 134a, 134b. The other clouds 134a, 134b may be different cloud systems or may be the same cloud. In some embodiments, the servers(s) 130 and storage 132 may not reside in other clouds, but still be located remote from the management system 120 and or the enterprise cloud 122.

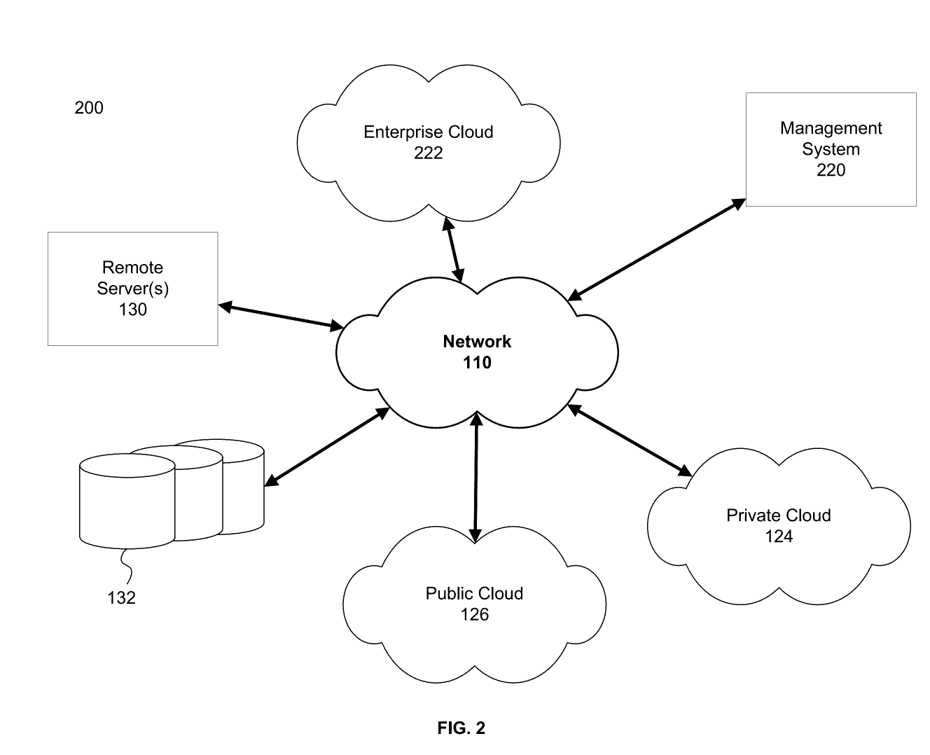

FIG. 2 is a system diagram of a cloud computing system 200, according to some other embodiments. In some embodiments, management system 220 may not be hosted by an enterprise cloud 222, but instead may be located remotely. Thus the management system 220 may provide cloud computing services remotely from a location off-premise of the enterprise cloud 222. In some embodiments, the management system 220 may be hosted by a service provider, such as service provider 128 or by another private cloud, such as private cloud 124. The management system 220 may provide cloud computing services and/or access resources exclusively from the enterprise cloud 222, or any combination of the enterprise cloud 222, private cloud 124, and public cloud 126. The management system 220, may include its own servers and storage, or may access remote servers 130 and storage 132.

Summary of certain example features further include:
Targets Intranet services as well as Internet services.
Create IT solutions anywhere, that is secure and isolated, integrated, and with redundancy, reliability, and stability.
Select and target the clouds that the customer cares about and needs—own, manage and/or control these clouds relevant to customer.
Ability to change and adapt when technology changes.
Deployment of new systems and solutions.
Consistent interface.
Automated control.
Provide customers with an end-to-end private cloud; offered as a service or a platform on a customer's hardware; that includes integrated applications.
Includes a network infrastructure.
Network topology is deployable.
Includes provisioning physical network devices.
Images are used to create physical devices that act as tunnels into private networks from the real world.
Security. Physical systems are isolated from any virtual networks. Allows compartmentalizing both IT risks and responsibility.
Delegate any level of control to a site/department.
Vendor agnostic. Uses any virtualization layer on commodity hardware.
Interrupt the intent of hackers, enabling the detection and remediation of both known and novel threats without impacting network performance.
Provide scalable solutions that are integrated into existing hardware.
Manage cloud-based and virtual network infrastructures providing virtual control, secure transport and fast setup for businesses of, for example, 100-5000 employees per appliance.
Reduce the possibility of compromise by hackers while providing control, security, manageability.
Integrate with existing networks.

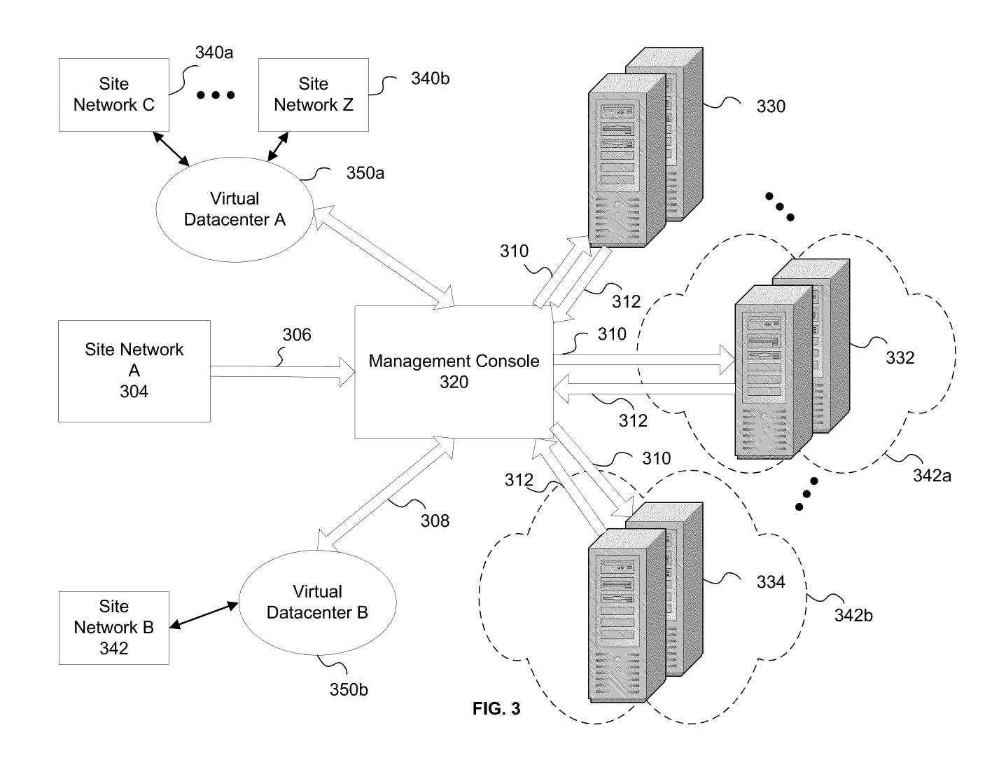

FIG. 3 is block diagram of a management console 320 that provides cloud computing services to site networks 304, 340, 342, according to some embodiments. In a cloud computing system, such as cloud computing system 100, management console 320 mediates between client needs at site networks 304, 340, 342 and physical systems 330, 332, 334. Site networks 304, 340, 342 may be individual users, an organization, or a community of organizations interconnected via an intranet or by the Internet (e.g., WAN, LAN, WLAN, and so on). Site networks 304, 340, 342 may be organized by physical location. Site networks 304, 340, 342 may also be logically organized irrespective of location. For example, site network A 304 may be a corporation located in specific city, but it may also be a corporation having entities in multiple cities interconnected via an intranet or over the Internet. Site network A 304 may also be, for example, a multinational corporation geographically located in multiple cities in multiple countries.

The management console 320 receives a request 306 for cloud computing services from site network A 304. The request may be from an individual user or a group of users at site network A 304. In some embodiments, the request 306 may be a collection of requests for cloud computing resources.

Based on the request 306, the management console 320 evaluates one or more factors associated with the request 306 and computes a set of rules or policies based on a weighted calculation of those factors. The rules or policies are then used to determine the best matched resources from physical systems 330, 332, 334 for instantiating one or more VMs that will service the request 306. In some embodiments, the one or more factors may be evaluated from the request 306. In other embodiments the management console 320 may consider, in addition to the request 306, one or more factors associated with the requestor, e.g., user(s) or organization(s). Management console 320 may also consider factors associated with the site network A 304 from which the request 306 originated. For example, pre-existing criteria may been in place that may have been established when site network A 304 was created or when the user/organization became a subscriber.

The management console 320 may place different weights with varying degrees on each of the one or more factors. The request 306 itself may define which of the factors should receive more weight over other factors. However, criteria associated with the requestor may also determine the varying weights. In some embodiments, assigning different weights may be automatically determined before computing the best-matched resources.

Once the management console 320 computes the policies for determining which resources are needed, the management console 320 communicates with physical system 330-334 and selects best matched physical machines based on the policies. The management console 320 instantiates one or more VMs from the selected physical machines, in a virtual datacenter 350. One or more VMs are executed and services are provided through the virtual datacenter 350. A virtual datacenter 350 is a virtualized collection of resources (VMs) that are isolated from the rest of the physical or virtualized resources that make up the greater cloud. This virtual datacenter is separated from the rest of the resources, both physical and virtual, through virtual network appliances such as the firewalls, network switches, routers and gateways. As such, this creates an isolated network of virtual resources in the cloud. The virtual datacenter 350 may support a single site network 342 or a plurality of site networks 340. An arbitrary number of virtual datacenters 350a and 350b can be instantiated by management console 320. The datacenters can be connected through secure gateways and firewalls to each other or the Internet. The virtual datacenters 350 communicate with the management console 320 to exchange instructions, update status changes, facilitate resources and services, and so on. In some embodiments, virtual datacenters 350 operate as a portal, such as a sub-cloud system, for facilitating activities of VMs that are instantiated for one or more site networks 342.

The management console 320 communicates via communication pathways 310, 312 with physical system 330-334. The management console 320, via pathway 310, communicates instructions to the physical system 330-334 for instantiating VMs on select physical machines. The management console 320 may additionally communicate status updates and other changes to the physical system 330-334. The status updates may be dynamically communicated or communicated based on a set schedule. The physical system 330-334 communicate, via pathway 312, to the management console 320 responses to instructions and requests from the management console 320 or to update the status of the physical systems 330-334. The communication to the management console 320 may also be dynamic, manual, or based on a set schedule.

Physical systems 330-334 may be on-premise and/or off-premise. For example, physical system 330 is on-premise with the management console 320. Physical systems 332, 334 are off-premise. The management console 320 may communicate with the off-premise systems 332, 334 via any number of network connections (e.g., intranet or Internet). In some embodiments, the off-premise systems 332, 334 may be at a remote location from the management console 320, or they may be hosted by other cloud networking systems 342, such as another private cloud or a public cloud. The physical systems 330-334 may be located locally at the same geographic located, or be dispersed regionally or globally.

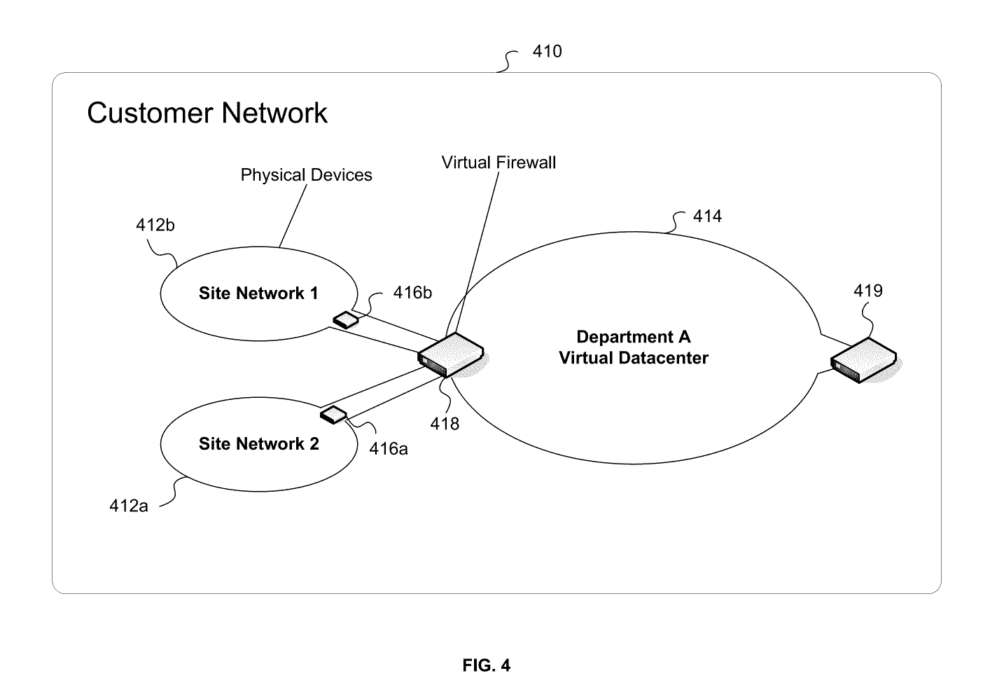

FIG. 4 is a detailed system diagram of a customer network 410 in communication with the management console 320 of FIG. 3, according to some embodiments. The customer network 410 may include one or more site networks 412. The sites 412 can be local or remote, geographically, to the virtual datacenter 414. The sites 412 can be local or remote, geographically, to the virtual datacenter 414. Each site network 412 includes designated physical devices, such as computers, laptops, mobile devices, and other client devices, storage, and so on, providing users at these devices to a gateway of software and other resources via a network in the cloud computing system. Each site network 412 accesses cloud computing service portal via a virtual datacenter 414 supplied and maintained by the management console 320 of FIG. 3.

Each site network 412 is provided with a client firewall 416 to the servicing virtual datacenter 414. Each communication must pass through the client firewall 416 in order to access cloud services via the virtual datacenter 414. In some embodiments, multiple firewalls may be implanted for additional protection, such as virtual firewall 418, which regulates the gateway into the virtual datacenter 414 once passed the client firewall 416. Similarly, another firewall 419 may be implemented to protect the gateway between the virtual datacenter 414 and the management console 320.

Examples of sites 414 might be remote offices sharing a departmental virtual datacenter, e.g. the finance department. The sites 414 could be separate entities, organizations or corporations that “need” to securely share virtualized resources. The virtual datacenter 414 could belong to the software development department of a company, site 412b is a local corporate develop team the site 412b is an off-shore contracted development team. This is useful because the virtual datacenter is extended to the “site network” not just individuals at both sites.

Another example of sites 412 accessing a virtual datacenter 414 is that of completely separate enterprises that need to share resources to optimize business relationships. In this application the virtual datacenter 414 acts to conjoin enterprises located at sites 412. A conjoined enterprise is separate but sharing vital business processes within the very same virtual datacenter. An example of separate enterprises that need to exchange business information is that of a contract manufacturer. The problem with today's separate enterprises is that contract manufacturer and their enterprise customers use “messages” that pass between each organization's ERP, MRP and sales order entry systems, for example. These “messages” have to be securely transmitted and “decoded” or “mapped” from one organizations internal format to that of the others. If the contract manufacturer and the enterprise could securely share these business systems, then they could be more tightly coupled “conjoined” and operate more effectively without the “decoding” or “mapping” issues arising. An example of conjoined enterprises could be site 412a is a contract manufacturer for the enterprise site 412b, the virtual datacenter can contain ERP, MRP and sales processing resources for both enterprises. As orders are placed from the sales resource the contract manufacturer is notified as if it were part of the enterprise itself. This could be extended to include OEM partners of an enterprise (they would place the orders into the sales resource), the contract manufacturer would be notified of the sales order, create the OEM job. Then the contract manufacturer could drop ship to the OEM, an invoice would be generated by the shared billing resource and the enterprise could recognize revenue on that sale.

Upon receiving a request for cloud services from within the customer network 410, the request is transmitted to the management console 320 via virtual datacenter 414 for processing. From the virtual datacenter 414, the management console 320 receives and processes requests.

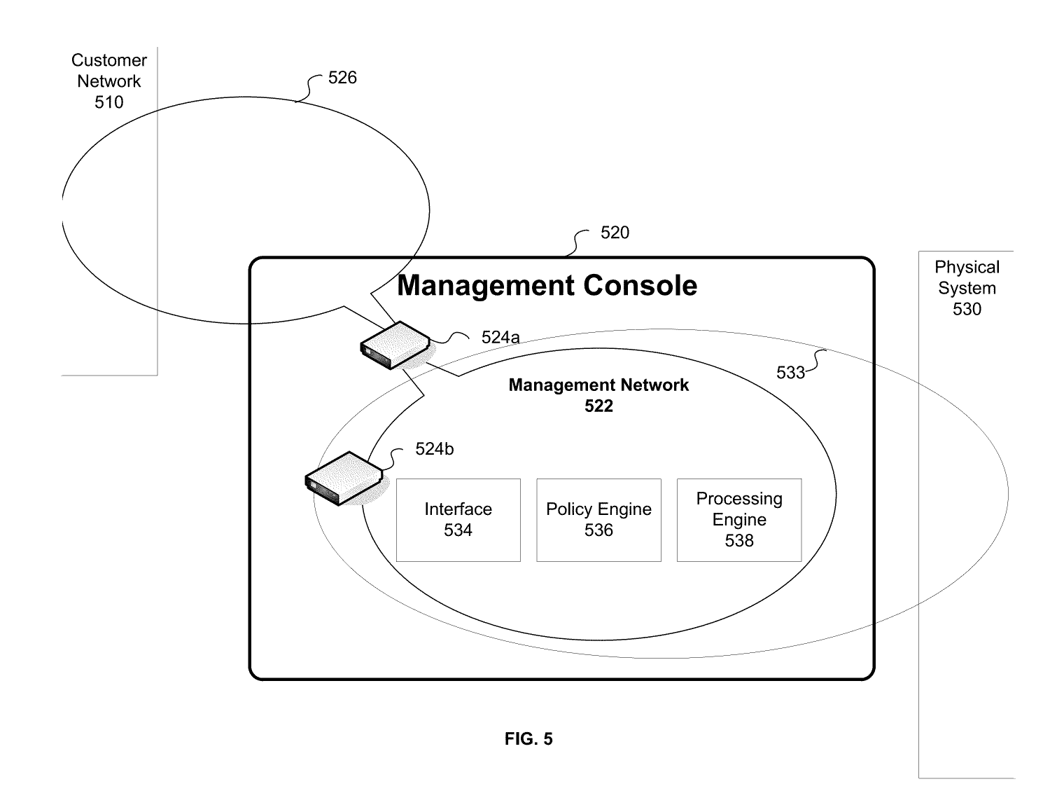

FIG. 5 is a system diagram illustrating a detailed view of the management console 320 of FIG. 3, according to some embodiments. A management console 520 includes one or more interfaces represented by interface 534, a policy engine 536, and a processing engine 538. These components of the management console 520 are part of an internal management network 522 for communicating with the customer network 510 and the network of the physical system 530, 533.

The interface 534 includes any interface that allows the management console 520 to communicate with virtual elements and elements in both the customer network 510, 526 and physical system network 530, 533. For example, the interface 534 includes one or more interfaces that allow the management console 520 to communicate with the VMs so that they can be managed by the management console 520. The interface 534 can be designed to support a plurality of platforms, giving the management console 520 the flexibility to utilize different VM platforms. The interface 534 may also support third party APIs that allow off-premise service providers access to the VM resources.

The management console 520 includes a policy engine 536 that computes rules for instantiating VMs based on weighted calculations, as previously described. Once the policy engine 536 generates the policies or rules for allocating resources of the physical system 530. The processing engine 538 further processes the rules and determines the physical machines for instantiating the VMs based on the set of policies. In some embodiments, the policy engine 536 and the processing engine 538 are on separate servers, while in other embodiments, both the policy engine 536 and processing engine 538 are on the same server.

As previously discussed, each gateway between the management console network 522 and the customer network 526 and between the management console network 522 and the physical system network 533, is protected by firewalls 524a and 524b, respectively.

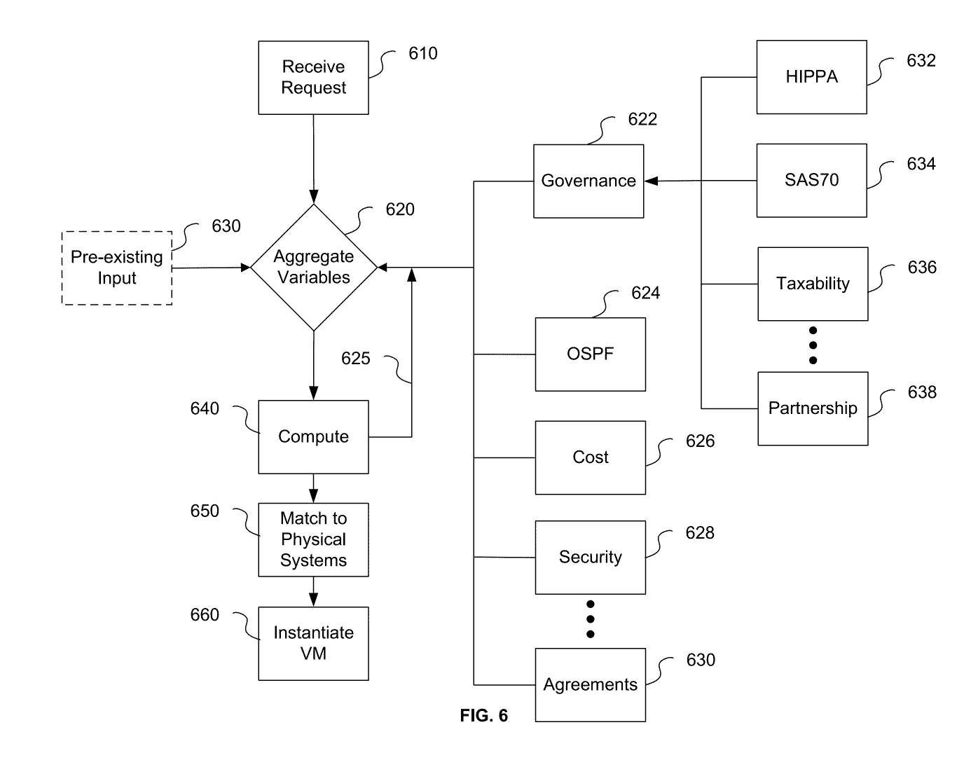

FIG. 6 is a flow chart illustrating the combined operation of the policy engine 536 and the processing engine 538 of FIG. 5, according to some embodiments. At step 610, a request for cloud computing services received. At step 620, variables (e.g. pre-existing criteria, factors, and so on) are aggregated in order to compute policies or rules at step 640.

At the variable aggregation step 620, any number of factors may be considered. The factors may be defined within the request at 610, or may have been previously established as pre-existing input 630. Pre-existing input at 630 includes any criteria that may have been defined based on the attributes of the user, organization, or community, as previously described. It also includes criteria based on attributes that may have been defined at the time of subscribing to the cloud computing services.

The factors may be organized according to varying degrees of relevance, in which case certain selected factors would be weighed more heavily than others for the policy computations.

Once the factors are aggregated and weighted, at step 640, a set of rules or policies are created. The policies are then used to process, at step 650, best matched physical machines to allocate for meeting the requested service, based on current information from the physical systems. At step 660, with the best matched physical machines determined, VMs are instantiated to service the request.

In some embodiments, more than one set of computation filters for generating policies may be executed, at step 640 depending on the degree of relevance of a set of factors. The factors may be divided into at least a highly relevant category and a lower relevancy category. Thus, at step 640, the first computation will create a set of rules based on the highly relevant category of factors. At step 625, a second computation may occur to further refine the first computation based on the lower relevancy category of factors. The second computation may be executed before or after processing the first set of rules or polices generated.

For example, a high availability resource such as a financial database, may weigh an SLA highly in a first filter, while weighing network location and price of services lower in a second filter. In this case, the highly relevant SLA may be used to generate a set of highly relevant rules in a first filtering. The first set of rules may be processed to determine multiple physical machines for allocating the VMs. A second computation of rules based on the lower relevant filters of network location and pricing may be executed to select refine the selection and determine the best matched physical machines.

Any number of factors may be considered.

For example, issues of governance 622 can be divided into subfactors that define the scope of the resources requested. For example, a site network in the health insurance industry may be interested in cloud computing resources that comply with HIPAA requirements 632. That being a highly relevant factor for this subscriber, the management console 520 would generate rules or policies that comply with HIPAA requirements, and select resources that only comply with HIPAA. Other governance issues may be determined by agreements, requirements or other contractual business and commerce obligations such as SAS70 (auditing and tracking) 634, taxability 636, compliance with business partnerships 638, SLAs, and so on.

Other factors besides governance, including but not limited to, may also be weighted or assigned a degree of relevance for weighting: OSPF (Open Shortest Path First) 624 (involving auditing/tracking), pricing and cost 626, security 628, agreements/contracts 630, location, latency, and other factors.

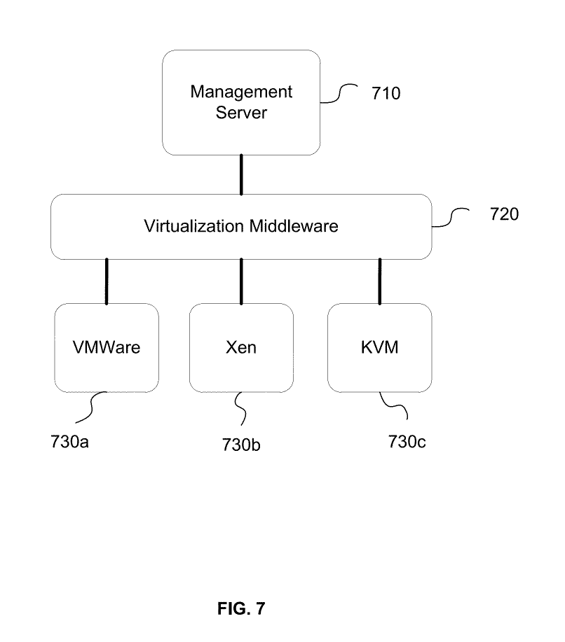

FIG. 7 is a block diagram illustrating the management system's ability to accommodate different virtualization platforms. This is one example aspect of the management system that allows for flexibility by not limiting or constraining location decisions the management console makes. This configuration also allows for business flexibility in that enterprises using the management console have the freedom to adjust virtualization middleware to better apply it to the changing needs of the business.

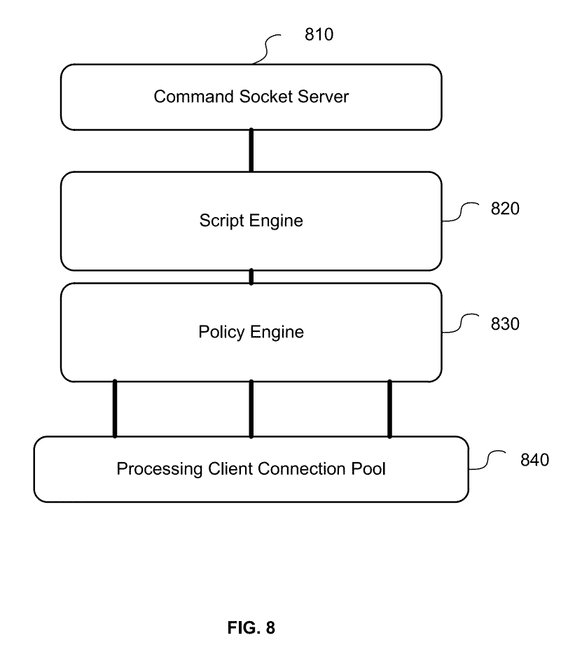

FIG. 8 is a block diagram illustrating functional components of the management system. From the bottom up the Processing Client Connection Pool 840 allows for multiple client or user requests to be made of the management system. This allows for a distributed server architecture. The Policy Engine 830 is used to evaluate the incoming client request based on a set of policies setup for that particular client, user or location depending on the incoming request. Policy is applied to the request and a the Script Engine 820 is called to generate a machine or virtualization layer instruction to fulfill the request, per the policy engines guidance. The Command Socket Server 810 then routes that instruction to the appropriate virtualization resource, the physical machine, the private cloud or the public cloud service.

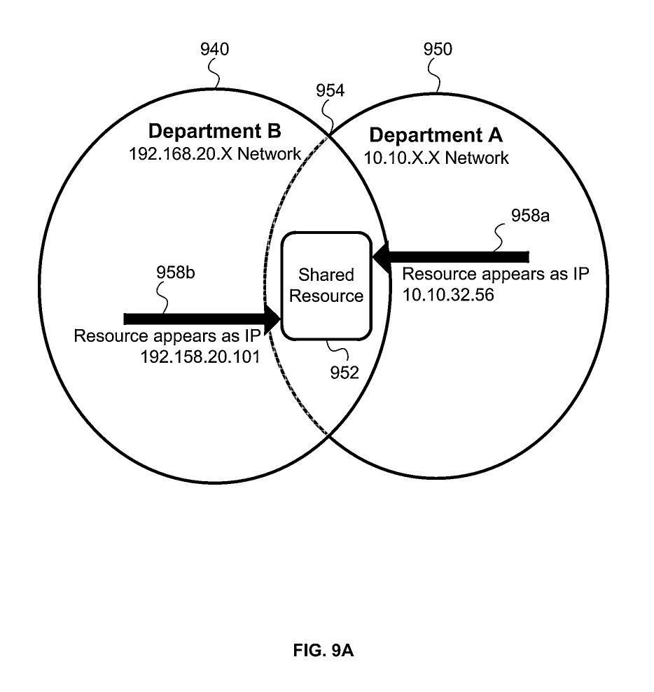

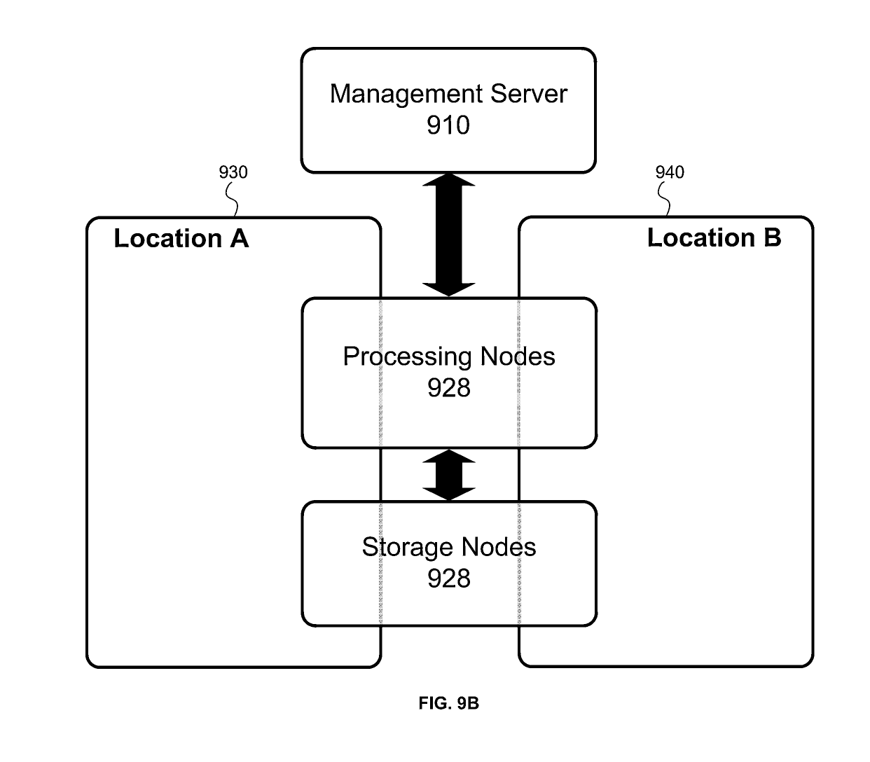

FIG. 9A is a Venn diagram further illustrating the concept of a virtual datacenter 414 in FIG. 4. In this diagram the Departments or sites or organizations 950 and 940 are illustrated as intersecting circles encapsulating the Shared Resource 952. In this case 940 and 950 are on completely different subnets and the Share Resource 952 is local, part of the same subnet as both departments. In should be noted that the Shared resource could be physical or virtual, local or on-premise with either 940 or 950 neither or both.

FIG. 9B is a block diagram illustrating that the management server is location agnostic. The management server can communicate with, instantiate and monitor Processing Nodes 928 and Storage Nodes 928 independent of their location at Location A 930 and/or Location B 940. Location A 930 and Location B 940 can represent the physical locations in which physical machines reside, an enterprise datacenter. Locations A and B, 930 and 940, can represent cloud service providers, both public and/or private.

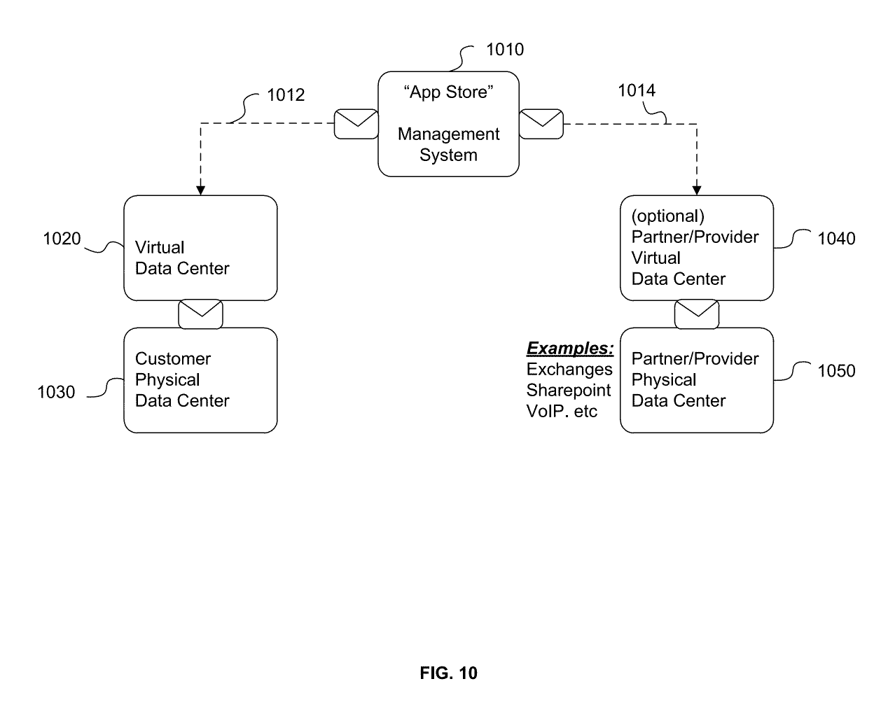

FIG. 10 is a block diagram representing management system user interface as an application store (“app store”) 1010. In this case, the user or client is presented with a “app store” interface to the management system. The user makes a request of the “app store”, e.g. create a resource. The management system evaluates the request, based on filters and policies to generate the “best” location for the placement of the resource requested. The management system then generates a request either 1012 or 1014, to allocate the resource. The virtual datacenter 1020 could be on-premise or off-premise to the Customer Physical Data Center 1030. The Partner/Provider Virtual Data Center 1040 could be established with a private cloud provider with an partner agreement or SLA with 1030. Making use of the underlying Physical Data Center 1050. The Partner 1040, 1050 could be a public cloud provide or a colocation server provider in a secure datacenter.

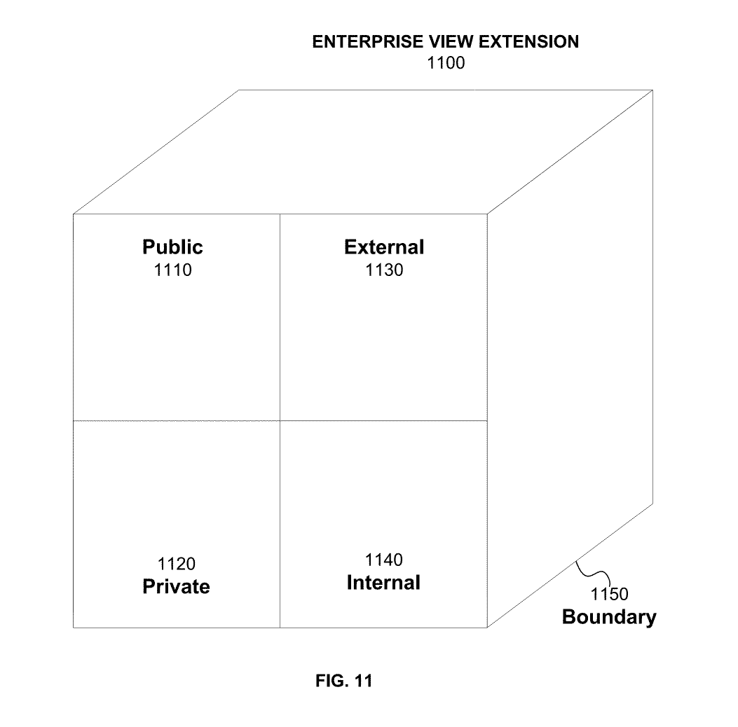

FIG. 11 represents the conceptual view of the enterprise cloud extended to cover various cloud formations. The cloud formations are defined as Public 1110, Private 1120, External 1130 and Internal 1140. This diagram implies that cloud resources can be Public resource 1110 and physically located both External 1130 and/or Internal 1140. The enterprise could be using or sharing those Public resources 1110 with other organizations or customers. The Private resources 1120 can also be External 1130 or Internal 1140 to the enterprise. Here the resources are physically owned by the enterprise and located in enterprise data centers or the resource are leased or collocated at a service provide External to the enterprise. The Boundary 1150 is the boundary of control that the enterprise has over all the cloud formations. The management console described here in extends that boundary around all the cloud formations for complete enterprise control and flexibility.

Transparency—in virtualization—includes having the ability to audit, e.g. SAS70. Trusted Monitoring installed at the cloud provider. The trusted monitor can provide “proofs of compliance”. The trusted monitor can be securely bootstrapped to run beside (securely isolated from) the IaaS and PaaS. This monitor can enforce access control policy and perform auditing as well as report non compliance (or opacity in the cloud environment).

Cloud authentication such as for SaaS and desktop virtualization to securely accessing systems and applications with a single signon or security token or 2 phase access.

Enterprises may not rely solely on contractual controls. Standards (transparency) are lacking for security and for managing Service Level Agreements (SLAs) that help with compliance, but are not currently open enough for third party audits. IT policies may require that virtual servers supporting certain applications must NOT share the same physical hardware. Transparency of a monitoring tool must provide minute details to monitor compliancy with these advanced policies.

Reduced provisioning times—self-service portals (allows Business Units to request, manage and track cloud resources) and automated workflows. Workflow is a set or defined series of tasks within an organization to produce a final outcome. An example of workflow, in the context of a self-service portals access to the Management Console 320 maybe a “new hire” in the organization. The use of self-service portal by the “new hire's” organization may call for the instantiation of a virtual desktop computing platform of the “new hire”. The self-service portal may be configured to allow the hiring manager to request the creation of a specific ‘class’ of virtual desktop for the new hire, but if the hiring manager requests a virtual desktop outside the default ‘class’, the request may be processed, but not immediately executed by the management console 320. The management console 320 may be configured to require additional approvals to instantiate this virtual desktop. In this case, the hiring manager's non-standard virtual desktop request would generate an approval request that would be sent to the hiring manager's manager. Once the approval was granted, the virtual desktop would be instantiated by the management console 320. Develop Business Intelligence capabilities to facilitate strategic capacity planning or migration. Business Intelligence aims to provide better tactical and strategic decisions for the business, using analytics, data mining, and event processing (to name a few). Business intelligence is facilitated by working in flexible environments that can conform to the rapidly changing requirements of the business. The cloud and virtual datacenter 414 in FIG. 4 sharing are examples of flexible computing and data sharing environments that can improve business intelligence.

Global virtualization manager that resides over the many machines with hypervisors. This architecture enables higher levels of resource utilization. Extend HA by allowing for automated VM restart in conjunction with networked storage. Also common disaster recovery architecture, independent of OS and applications in the event of disaster, to enable rollover of designated applications within a resource pool to another site.

The cloud computing system of 100 and 200 may include additional features that enhances security (including authentication) and governance, and that utilizes metadata to achieve these objectives. Information-centric security is like, for example, the data itself has metadata, e.g. the information is self-protecting. The data may be self-describing and defending regardless of environment. Data can be encrypted and packaged with a usage policy. When the data is accessed it should consult its policy and attempt to recreate a secure environment using VM and reveal itself only if the environment is verified as trustworthy.

Enterprises may not solely rely on contractual controls for secure instantiation of virtual resources. In some embodiments, to achieve trusted computing, meta data embedded within compute images and applications that can query hypervisor meta data to control or manage Business Intelligence (BI). This could include location requirements, access control, hypervisor selection, co-location, cloud provider, tax safe harbor, data location, etc.

Additionally, the Meta Data could contain a cryptographic key or token that is used to authorize initialization. The Meta Data itself may need to be encoded or encrypted for security reasons. The entire virtual image maybe digital signed to ensure that nothing has tampered with it. This digital signature may reside with the Meta Data of the virtual resource. Finally the entire virtual resource image maybe encrypted to ensure that, only authorized systems can even access the data, to instantiate the resource. To prevent spoofs or hacks allowing unauthorized instantiation.

OVF (open virtualization format) is an open standards based format for distributing virtual appliances or more general resource to be run as virtual machines. The OVF allows for meta data to be added to VM images and allows for the extension of that data. This is one possible mechanism to utilize to create and inject the Meta Data described above, but is not limited solely to this format.

TPM (Trust Platform Module) a TC (trusted computing) variant is supported by Linux 2.6.13+ and Intel's TXT (trusted execution technology) allows memory isolation even from the OS. As part of memory curtaining to secure digital rights from another process. The TPG process allows for “attestation identities” that can cryptographically be allowed access to or to run or play specific software. This could be used to validate in a Digital Rights Management (DRM) fashion the ability to launch and run applications within a specific framework or set of frameworks.

In a Digital Rights Management fashion or the PKI (public Key Infrastructure) encryption mechanisms describes above. The management console could be an authority that generates and distributes these keys securely. The management console when required for extra security could generate a public/private key pair then digitally sign, encrypt or encode elements of the Meta Data or the entire virtual resource using the private key. Then securely distribute the public key only to those service providers or clouds that are “authorized” to access, instantiate or other make use of that virtual resource. The management console could also make use of PKI and other commercial certificate authorities to generate, encrypt and distribute keys securely.

Additional embodiments supported by the cloud computing systems previously described additionally include such features as, for example:
Transparency of access between enterprises and cloud computing resources.
Generating detailed audit trails from resources within the system, e.g., SAS70, taxable data, etc.
Tracking requests, actions, and activities to allow for rollback capabilities (in contrast to snapshots, although snapshots would also be possible) in order to unwind transactions an return to certain points or levels at any stage of the transaction(s).
Virtual Network Security: Designed to ensure the security of cloud-based, virtual networks and servers are not compromised. In some embodiments, this may be achieved by using a virtual serial port versus providing direct network access to physical machines. This eliminates the possibility of compromise by hackers.
Easy Integration with Existing Hardware: transparently integrate into existing hardware straight out of the management console described above. APIs and connectors are included in every management console that will automatically survey and map a customer's network(s)-eliminating hours or even days of inventory and data entry. A dashboard of the management console, described above, works with all existing network consoles including, for example, HP Openview and IBM Tivoli, and supplies its own dashboard for optimal usability.
Minimize Downtime and Protect Against Data Loss: Assist with companies/customers avoid disruption in business operations, loss of important information, and downtime by enabling administrators with Internet access to reboot from anywhere on the network in order to keep drives and discs in sync. Through the rules/policy engine described above, administrators have complete control to generate scriptable tags for both servers and networks. The rules/policy engine allows businesses to reroute servers and networks to meet a variety of local and regional requirements.

It will further be appreciated that some elements described above share the same reference numerals, where the corresponding description applies to these elements sharing the same reference numerals. In the interest of brevity, the description common to these elements have not been described again.

The foregoing description, for purpose of explanation, has been described with reference to specific embodiments. However, the illustrative discussions above are not intended to be exhaustive or to limit the invention(s) to the precise forms disclosed. Many modifications and variations are possible in view of the above teachings. The embodiments were chosen and described in order to best explain the principles of the invention(s) and its practical applications, to thereby enable others skilled in the art to best utilize the invention(s) and various embodiments with various modifications as are suited to the particular use contemplated.

We claim:

1. A system comprising:
at least one computer server including at least a cloud computing manager configured to:
determine a location for instantiating at least one virtual machine in at least one cloud network (122, 124, 126) using a weighted rating engine;
interface with at least one user via a management console (320, 520); and
communicate with the at least one cloud network.

2. The system of claim 1 wherein the manager is further configured to:
communicate the determination of the location for instantiating the at least one virtual machine to the at least one user;
receive user information regarding the determination; and
instantiate the at least one virtual machine at a location in the cloud network based on the received user information.

3. The system of claim 1 wherein the manager is further configured to:
instantiate the at least one virtual machine at a location in the cloud network based on the location determined by the weighted rating engine.

4. The system of claim 1 wherein the manager is hosted by a cloud service provider (122).

5. The system of claim 1 wherein the manager is hosted in a private cloud (124) available only to one enterprise.

6. The system of claim 1 wherein the location that the weighted rating engine determines to instantiate the at least one virtual machine is in a public cloud network (126).

7. The system of claim 1 wherein the location that the weighted rating engine determines to instantiate the at least one virtual machine is in a private cloud network (124).

8. The system of claim 1 wherein the location that the weighted rating engine determines to instantiate the at least one virtual machine is in an enterprise physical resource (222).

9. The system of claim 1 wherein the manager is further configured to cluster at least two management consoles, wherein the two or more management consoles are each configured to make at least one request into the system.

10. The system of claim 1 wherein the manager is further configured to include at least one hypervisor in the determination of the location of the instantiation of the at least one virtual machine.

11. The system of claim 1 wherein the manager is further configured to generate at least one report including at least information regarding the location in the at least one cloud network of the at least one virtual machine.

12. A system comprising:
at least one computer server including at least a cloud computing manager configured to:
determine a location for instantiating at least one virtual machine in at least one cloud network via a weighted rating engine using at least one key factor;
interface with at least one user via a management console;
communicate with the at least one cloud network; and
instantiate the at least one virtual machine in the at least one cloud network based on the determination of the weighted rating engine.

13. The system of claim 12 wherein the at least one key factor includes an actual cost to instantiate the at least one virtual machine.

14. The system of claim 12 wherein the at least one key factor includes network latency from a point of use to the at least one virtual machine.

15. The system of claim 12 wherein the at least one key factor includes information from at least one governmental requirement regarding the function of the at least one virtual machine.

16. The system of claim 15 wherein the governmental requirement includes information regarding at least one of: health regulations, tax regulations, and financial regulations.

17. The system of claim 12 wherein the manager is further configured to generate at least one report including at least information regarding the location in the cloud network of the at least one virtual machine.

18. The system of claim 12 wherein the manager is further configured to generate at least one report including at least information regarding the key factors used for determination of the location of the at least one virtual machine.

19. A distributed management system comprising:
at least one computer server including at least a cloud computing manager configured to:
determine a location for instantiating at least one virtual machine in at least one cloud network via a weighted rating engine using at least one key factor;
interface with at least one user via at least two management consoles;
communicate with the at least one cloud network; and
instantiate at least one virtual machine in the at least one cloud network based on the determination of the weighted rating engine.

20. The distributed management system of claim 19 wherein the at least two management consoles are configured to receive requests regarding instantiation of at least one virtual machine from at least one of a remote: site, entity and organization.

21. The distributed management system of claim 20 wherein the at least two management consoles are further configured to:
receive rules that limit the requests of the at least one remote, the limit including at least one of:
location of the at least one virtual machine,
type of virtual machine,
number of virtual CPUs utilized,
amount of storage used, and
amount of memory used.

22. The distributed management system of claim 19 wherein the instantiation of the at least one virtual machine is in the at least one cloud network.

23. The distributed management system of claim 20 wherein the instantiation of the at least one virtual machine is in the at least one physical resource of the requesting remote.
